(19) United States
(12) Patent Application Publication
(10) Pub. No.: US 2024/0403596 A1
(43) Pub. Date: Dec. 5, 2024

(54) CHATBOT TO TRANSLATE FOR INSURANCE CUSTOMERS

(71) Applicant: STATE FARM MUTUAL AUTOMOBILE INSURANCE COMPANY, Bloomington, IL (US)

(72) Inventors: Joseph Robert Brannan, Bloomington, IL (US); Vicki King, Bloomington, IL (US); Brian Mark Fields, Phoenix, AZ (US); Nathan L. Tofte, Downs, IL (US)

(21) Appl. No.: 18/234,458

(22) Filed: Aug. 16, 2023

Related U.S. Application Data
(60) Provisional application No. 63/525,203, filed on Jul. 6, 2023.
(60) Provisional application No. 63/471,115, filed on Jun. 5, 2023.

(51) Int. Cl. G06N 3/006; G06F 40/284; G06F 40/58; G06Q 30/02; G06Q 40/08

(52) U.S. Cl. CPC G06N 3/006; G06F 40/284; G06F 40/58; G06Q 30/0278; G06Q 40/08

(57) ABSTRACT

The following relates generally to artificial intelligence (AI)-based communication with an insurance customer. In some embodiments, one or more processors: receive, via a chatbot (or voicebot or other bot), a question in a first language; translate, via the chatbot, the question from the first language to a second language; determine, via the chatbot, an answer to the translated question, the answer being determined in the second language; translate, via the chatbot, the answer from the second language to the first language; and/or present, via the chatbot, the answer in the first language to an insurance customer.

### CROSS REFERENCE TO RELATED APPLICATIONS

This application claims the benefit of: (1) U.S. Provisional Application No. 63/525,203, entitled “Chatbot To Translate For Insurance Customers” (filed Jul. 6, 2023); and (2) U.S. Provisional Application No. 63/471,115, entitled “Chatbot To Translate For Insurance Customers” (filed Jun. 5, 2023), the entirety of each of which is incorporated by reference herein.

### FIELD

The present disclosure generally relates to artificial intelligence (AI)-based communication with an insurance customer.

### BACKGROUND

Sometimes an insurance customer and an insurance agent may not speak the same language. Currently, this problem may be solved by finding a translator to translate between the insurance customer and insurance agent. However, this solution is cumbersome and inefficient.

The systems and methods disclosed herein provide solutions to these problems and may provide solutions to the ineffectiveness, insecurities, difficulties, inefficiencies, encumbrances, and/or other drawbacks of conventional techniques.

### SUMMARY

The present embodiments relate to, inter alia, AI-based communication with an insurance customer. For example, an AI and/or machine learning (ML) Chatbot may translate between different languages to help insurance customers. When an insurance customer asks a question to the chatbot, the chatbot may translate the language of the question, determine an answer to the question, and then translate the answer back to the language that the question was asked in. Additionally or alternatively, the chatbot may translate the language, and provide the translation to an insurance agent; in this way, the insurance agent may help answer at least part of the question. The chatbot may be trained on a historical dataset of past conversations between insurance agents and insurance customers. Advantageously, embodiments disclosed herein help insurance companies because using techniques described herein insurance companies no longer have to find a specific individual to speak a specific language. Embodiments disclosed herein also advantageously help blind or deaf people.

In one aspect, a computer-implemented method for artificial intelligence (AI)-based communication with an insurance customer may be provided. The method may be implemented via one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For instance, in one example, the method may include: (1) receiving, via a chatbot of one or more processors, a question in a first language; (2) translating, via the chatbot, the question from the first language to a second language; (3) determining, via the chatbot, an answer to the translated question, the answer being determined in the second language; (4) translating, via the chatbot, the answer from the second language to the first language; and/or (5) presenting (such as verbally or audibly speaking or presenting, or displaying on a display screen or otherwise displaying), via the chatbot, the answer in the first language to an insurance customer. The method may include additional, fewer, or alternate actions, including those discussed elsewhere herein.

In another aspect, a computer system configured for artificial intelligence (AI)-based communication with an insurance customer may be provided. The computer system may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For example, in one instance, the computer system may include one or more processors configured to: (1) receive, via a chatbot, a question in a first language; (2) translate, via the chatbot, the question from the first language to a second language; (3) determine, via the chatbot, an answer to the translated question, the answer being determined in the second language; (4) translate, via the chatbot, the answer from the second language to the first language; and/or (5) present, via the chatbot, the answer in the first language to an insurance customer. The computer system may include additional, less, or alternate functionality, including that discussed elsewhere herein.

In yet another aspect, a computer device configured for improved artificial intelligence (AI) insurance analysis may be provided. The computer device may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For instance, in one example, the computer device may include: one or more processors; and/or one or more memories coupled to the one or more processors. The one or more memories including computer executable instructions stored therein that, when executed by the one or more processors, may cause the one or more processors to: (1) receive, via a chatbot, a question in a first language; (2) translate, via the chatbot, the question from the first language to a second language; (3) determine, via the chatbot, an answer to the translated question, the answer being determined in the second language; (4) translate, via the chatbot, the answer from the second language to the first language; and/or (5) present, via the chatbot, the answer in the first language to an insurance customer. The computer device may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates an exemplary computer system for recommending a change in insurance coverage, according to one embodiment.

FIG. 2 depicts an exemplary combined block and logic diagram for exemplary training of an exemplary chatbot.

FIG. 3 illustrates an exemplary screen displaying a chat session between an insurance customer and a chatbot.

FIG. 4 illustrates an exemplary screen displaying a chat session between an insurance agent and the chatbot, including displaying a suggested answer to the insurance customer's question.

FIG. 5 illustrates an exemplary screen displaying a chat session between an insurance agent and the chatbot, including allowing the insurance agent to modify the suggested answer.

FIG. 6 illustrates an exemplary screen displaying a chat session between an insurance agent and the chatbot, including allowing the insurance agent to replace the suggested answer.

FIG. 7 illustrates an exemplary computer-implemented method of AI-based communication with an insurance customer.

FIG. 8 illustrates an exemplary computer-implemented method, including presenting a suggested answer to an insurance agent.

### DETAILED DESCRIPTION

The present embodiments relate to, inter alia, AI-based communication with an insurance customer. For instance, an AI and/or machine learning (ML) Chatbot may translate between different languages to help insurance customers. When an insurance customer asks a question to the chatbot, the chatbot may translate the language of the question, determine an answer to the question, and then translate the answer back to the language that the question was asked in. Additionally or alternatively, the chatbot may translate the language, and provide the translation to an insurance agent; in this way, the insurance agent may help answer at least part of the question. The chatbot may be trained on a historical dataset of past conversations between insurance agents and insurance customers. Advantageously, embodiments disclosed herein help insurance companies because using techniques described herein insurance companies no longer have to find a specific individual to translate between languages. Embodiments disclosed herein also advantageously help blind or deaf people.

### Exemplary System

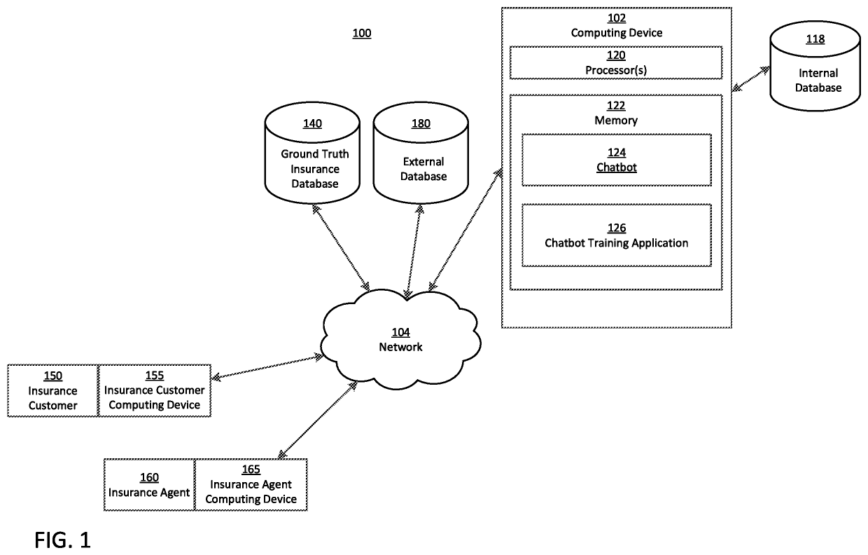

To this end, FIG. 1 illustrates an exemplary computer system 100 for AI-based communication with an insurance customer in which the exemplary computer-implemented methods described herein may be implemented. The high-level architecture includes both hardware and software applications, as well as various data communications channels for communicating data between the various hardware and software components.

The exemplary system 100 may include computing device 102, which may include one or more processors 120, such as one or more microprocessors, controllers, and/or any other suitable type of processor. The computing device 102 may further include a memory 122 (e.g., volatile memory, non-volatile memory) accessible by the one or more processors 120, (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 122 may include instructions for executing various applications, such as chatbot 124 (which may additionally or alternatively be voicebot 124, and/or a Chat-GPT bot or Chat-GPT based bot), and/or chatbot training application 126.

An insurance company that owns the computing device 102 may provide insurance to insurance customers, such as the insurance customer 150. For example, the insurance company may also provide insurance policies, such as a life insurance policy, a homeowners insurance policy, a renters insurance policy, an auto insurance policy, an umbrella insurance policy, and/or a disability insurance policy, etc. As such, in some situations, it may be useful for the insurance company to answer questions from the insurance customer 150 in a language spoken by the insurance customer 150.

To this end, the chatbot 124 may, inter alia, have a conversation with and/or answer questions from the insurance customer 150. Additionally or alternatively, the chatbot 124 may translate a question from the insurance customer 150, and provide the translated question to the insurance agent 160 (e.g., via the insurance agent computing device 165). In some such examples, the chatbot 124 also provides a suggested answer to the insurance agent 160, which the insurance agent 160 may accept, reject, or modify. Furthermore, it should be understood that although 124 is labeled as chatbot, 124 may additionally or alternatively be a voicebot. It should further be understood that chatbot/voicebot 124 may be an AI and/or ML chatbot/voicebot.

In some examples, the chatbot 124 receives a question in a first language from the insurance customer computing device 155. The chatbot 124 may then translate the question into a second language, and determine an answer to the translated question in the second language. The chatbot 124 may then translate the answer from the second language to the first language, and provide the translated answer to the insurance customer 150 (e.g., via the insurance customer computing device 155).

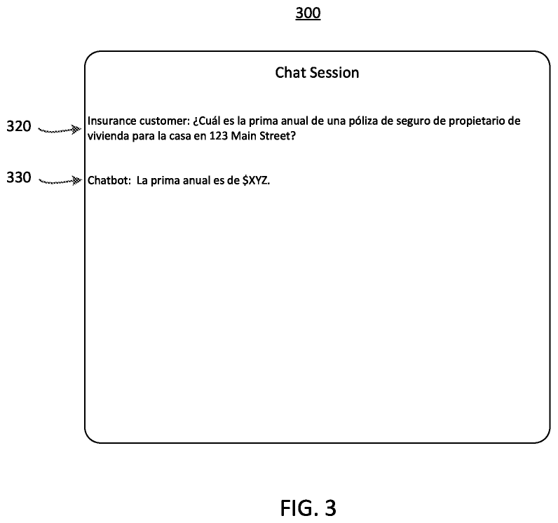

For instance, as illustrated in the exemplary screen 300 of FIG. 3, the insurance customer 150 may ask question 320 in Spanish (e.g., a first language). Specifically, in the illustrated example, the insurance customer 150 asks the question: ¿ Cuál es la prima anual de una póliza de seguro de propietario de vivienda para la casa en 123 Main Street?” The chatbot 124 may then translate the question to English (e.g., a second language). In the illustrated example, the question 320 translates to: “What is the annual premium for a homeowners insurance policy for the house at 123 Main street?” The chatbot may then determine an answer in English to the question, and then translate the answer back to Spanish. In the illustrated example, the answer determined in English is: “The annual premium is $XYZ;” and the translation to Spanish is “La prima anual es de $XYZ,” as illustrated in answer 330.

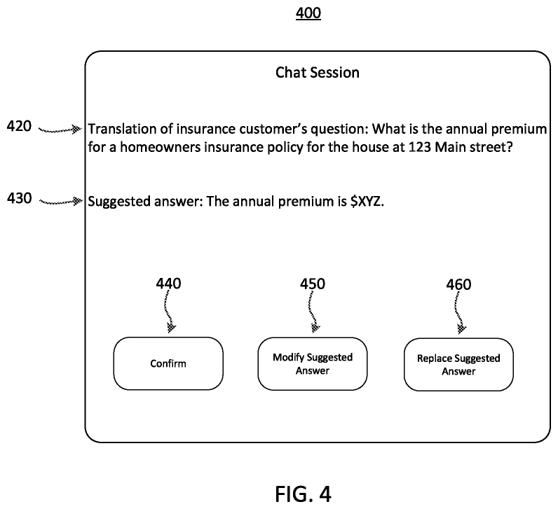

In some examples, the chatbot 124 may determine an answer to the question without human intervention. However, in other examples, the chatbot presents a suggested answer to the insurance agent 160, such as in the example of FIG. 4. More specifically, FIG. 4 depicts exemplary screen 400 presenting the question translation 420 of the question 320 from the example of FIG. 3. The exemplary screen 400 also presents suggested answer 430, and allows the insurance agent 160 to: confirm (e.g., approve) the suggested answer (e.g., by selecting button 440); modify the suggested answer (e.g., by selecting button 450), or replace the suggested answer (e.g., by selecting button 460).

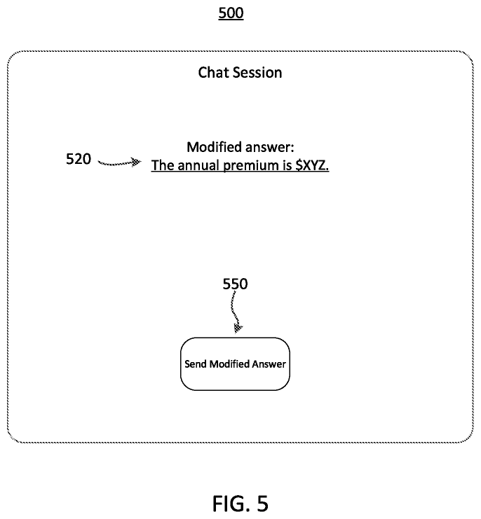

If the insurance agent 160 decides to modify the suggested answer (e.g., by selecting button 450), the exemplary screen 500 as in the example of FIG. 5 may be displayed. In the illustrated example, the insurance agent 160 may enter the modified answer into the modified answer area 520 of the exemplary screen 500. In the illustrated exemplary screen 500, the modified answer area 520 has been prepopulated with the suggested answer. Advantageously, prepopulating the modified answer area 520 with the suggested answer allows the insurance agent 160 to quickly modify the suggested answer. For example, the insurance agent 160 may quickly change the “XYZ” to “ABC.” The insurance agent 160 may send the modified answer by pressing button 550.

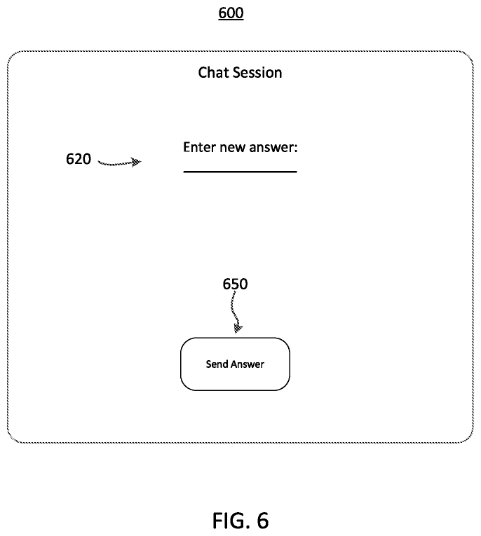

If the insurance agent 160 decides to replace the suggested answer (e.g., by selecting button 460), the exemplary screen 600 as in the example of FIG. 6 may be displayed. In the illustrated example, the insurance agent 160 may enter the replacement answer into the replacement answer area 620 of the exemplary screen 600. The insurance agent 160 may send the replacement answer by pressing button 650.

In some instances, the chatbot 124 may access an estimation AI algorithm. For example, in responding to homeowners insurance questions, the chatbot 124 may access an estimation AI or ML algorithm to estimate a home value, and provide the estimation at part of the answer to the insurance customer's 150 question.

Additionally or alternatively, the chatbot 124 may access a conversation AI or ML algorithm to determine answers to the questions from the insurance customer 150. In some examples, the conversation AI or ML algorithm includes a homeowners insurance AI or ML algorithm, a renters insurance AI or ML algorithm, an auto insurance AI or ML algorithm, a life insurance AI or ML algorithm, a disability AI or ML algorithm, and/or an umbrella AI or ML algorithm.

The chatbot 124 may be trained by the chatbot training application 126. It should be appreciated that the techniques discussed herein with respect to training a chatbot via the chatbot training application 126 apply equally as well to training a voice bot. Broadly speaking, the chatbot training application 126 may train the chatbot 124 to translate questions and/or answers, as well as determine and/or suggest answers to questions. The training of the chatbot 124 is described in more detail elsewhere herein.

Advantageously, to answer the questions, the chatbot 124 may access information from the ground truth database 140. Further advantageously, the chatbot 124 may be trained using information from the ground truth insurance database 140. In particular, this is advantageous because the ground truth insurance database 140 holds information that is more reliable than other sources; and, more specifically, holds information that is more reliable and particularly useful for insurance purposes. More particularly, the ground truth insurance database 140 may hold information vetted by the insurance company. For instance, the insurance company may verify information before storing it in the ground truth insurance database 140.

Examples of the information held by the ground truth insurance database 140 include: (i) information from an insurance company application (app), (ii) anonymized insurance claim information, (iii) historical conversations between insurance customers and insurance agents, (iv) police report information, etc. The information held by the ground truth database 140 may include information of any type, such as text information, imagery information (e.g., images, video, etc.), audio information, etc.

The external database 180 may be a database holding any suitable information. However, unlike the information in the ground truth database, the insurance company does not independently verify the information in the external database 180.

The insurance customer 150 may view the answer(s) to her question on the insurance customer computing device 155, which may comprise any suitable computing device, such as a computer, a smartphone, a laptop, a phablet, etc. The insurance customer computing device 155 may include one or more processors, such as one or more microprocessors, controllers, and/or any other suitable type of processor. In addition, it should be appreciated that the insurance customer 150 may be a current insurance customer of an insurance company, or a potential insurance customer of the insurance company (e.g., a customer shopping for insurance).

The exemplary system 100 may also include the insurance agent computing device 165, which may comprise any suitable device, such as a computer, a smartphone, a laptop, a phablet, etc. The insurance agent computing device 165 may be operated by the insurance agent 160. In some examples, the insurance agent 160 views, approves (e.g., confirms that the suggested answer is correct), modifies, and/or replaces the recommendation for an insurance change before it is sent to the insurance customer computing device 155.

In addition, further regarding the example system 100, the illustrated exemplary components may be configured to communicate, e.g., via the network 104 (which may be a wired or wireless network, such as the internet), with any other component. Furthermore, although the example system 100 illustrates only one of each of the components, any number of the example components are contemplated (e.g., any number of computing devices, insurance customer computing devices, insurance agent computing devices, ground truth insurance databases, external databases, etc.).

### Exemplary Training of an Exemplary Chatbot

An insurance company may use chatbot 124 to, inter alia, provide tailored, conversational-like services (e.g., answering insurance questions, etc.). The chatbot 124 may be capable of understanding requests, providing relevant information, escalating issues. Additionally, the chatbot 124 may generate data from interactions which the enterprise may use to personalize future support and/or improve the chatbot's functionality, e.g., when retraining and/or fine-tuning the chatbot. Moreover, although the following discussion may refer to an ML chatbot or an ML model, it should be understood that it applies equally to an AI chatbot or an AI model.

The chatbot 124 may be trained by chatbot training application 126 using large training datasets of text which may provide sophisticated capability for natural-language tasks, such as answering questions and/or holding conversations. The chatbot 124 may include a general-purpose pretrained LLM which, when provided with a starting set of words (prompt) as an input, may attempt to provide an output (response) of the most likely set of words that follow from the input. In one aspect, the prompt may be provided to, and/or the response received from, the chatbot 124 and/or any other ML model, via a user interface of the computing device 102. This may include a user interface device operably connected to the server via an I/O module. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances, which may require the chatbot 124 to keep track of an entire conversation history as well as the current state of the conversation. The chatbot 124 may rely on various techniques to engage in conversations with users, which may include the use of short-term and long-term memory. Short-term memory may temporarily store information (e.g., in the memory 122 of the computing device 102) that may be required for immediate use and may keep track of the current state of the conversation and/or to understand the user's latest input in order to generate an appropriate response. Long-term memory may include persistent storage of information (e.g., the internal database 118 of the computing device 102) which may be accessed over an extended period of time. The long-term memory may be used by the chatbot 124 to store information about the user (e.g., preferences, chat history, etc.) and may be useful for improving an overall user experience by enabling the chatbot 124 to personalize and/or provide more informed responses.

In some embodiments, the system and methods to generate and/or train an ML chatbot model (e.g., via the chatbot training application 126) which may be used in the chatbot 124, may include three steps: (1) a supervised fine-tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning ML Model

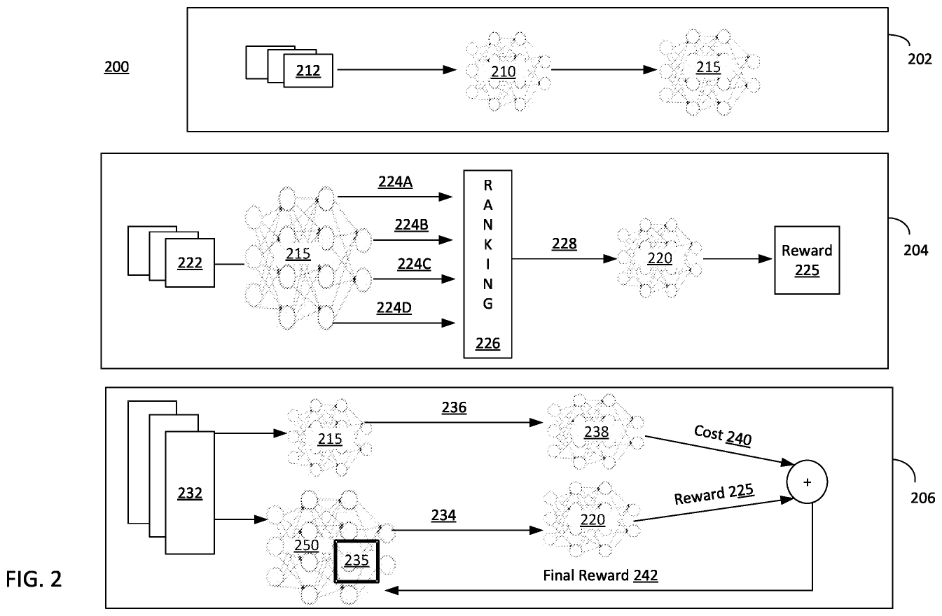

As an initial matter, although the discussion with respect to FIG. 2 refers to ML model 250, it should be understood that 250 may refer equally to an AI and/or ML algorithm and/or model. In addition, in some embodiments, the ML model 250 may comprise a conversation AI or ML algorithm, which may comprise a homeowners insurance AI or ML algorithm, a renters insurance AI or ML algorithm, an auto insurance AI or ML algorithm, a life insurance AI or ML algorithm, a disability insurance AI or ML algorithm, and/or an umbrella insurance AI or ML algorithm are comprised in a conversation AI or ML algorithm.

FIG. 2 depicts a combined block and logic diagram 200 for training an ML chatbot model, in which the techniques described herein may be implemented, according to some embodiments. It should be understood that FIG. 2 may apply to training any chatbot described herein, and FIG. 2 should not be considered to be restricted to the chatbot 124. In addition, the chatbot 124 may be trained in accordance with any of the other techniques described herein; and the training of chatbot 124 should not be considered restricted to the teachings of FIG. 2.

Some of the blocks in FIG. 2 may represent hardware and/or software components, other blocks may represent data structures or memory storing these data structures, registers, or state variables (e.g., 212), and other blocks may represent output data (e.g., 225). Input and/or output signals may be represented by arrows labeled with corresponding signal names and/or other identifiers. The methods and systems may include one or more blocks 202, 204, 206, which will be described in further detail below.

In one aspect, at block 202, a pretrained language model 210 may be fine-tuned. The pretrained language model 210 may be obtained at block 202 and be stored in a memory, such as memory 122 and/or internal database 118. The pretrained language model 210 may be loaded into an ML training module at block 202 for retraining/fine-tuning. A supervised training dataset 212 may be used to fine-tune the pretrained language model 210 wherein each data input prompt to the pretrained language model 210 may have a known output response for the pretrained language model 210 to learn from. The supervised training dataset 212 may be stored in a memory at block 202, e.g., the memory 122 or the internal database 118. In one aspect, the data labelers may create the supervised training dataset 212 prompts and appropriate responses. The pretrained language model 210 may be fine-tuned using the supervised training dataset 212 resulting in the SFT ML model 215 which may provide appropriate responses to user prompts once trained. The trained SFT ML model 215 may be stored in a memory, such as the memory 122 or the internal database 118.

In one aspect, the supervised training dataset 212 may include prompts and responses (e.g., questions and answers, etc.) which may be relevant to insurance customer 150 and/or insurance agent 160. Examples of prompts and responses include insurance customer questions, and corresponding insurance agent answers. For instance, an insurance customer 150 may ask (e.g., create an input prompt asking) “what would the monthly auto insurance premium be for this car?” Example responses from the trained SFT ML model 215 may include “the monthly premium would be $XYZ.” or “please provide the following information to determine the monthly premium: make/model/year of car.” The responses may include one or both of an answer to the question and/or an insurance-related suggestion. In some embodiments, the supervised training dataset 212 may include historical data from or be based upon historical data from the internal database 118, the ground truth insurance database 140, and/or the external database 180.

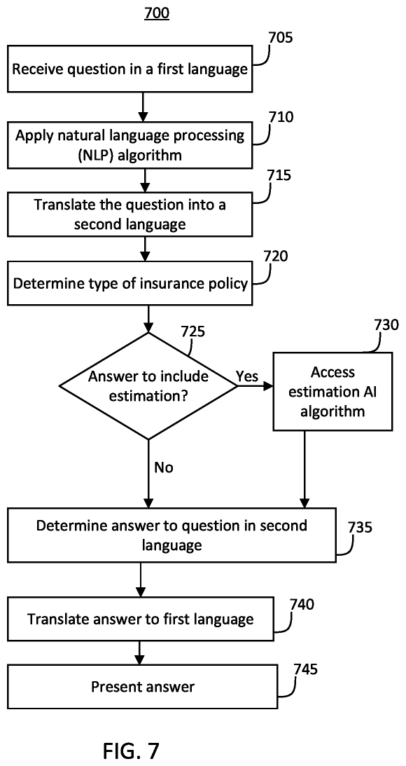

Moreover, the supervised training dataset 212 may include prompts and responses in a single language, such as the second language referred to in FIG. 7. In this regard, it should be appreciated that when the following discussion refers to a second language, it refers to the second language referenced in FIG. 7. Moreover, training the chatbot 124 in the second language has a technical advantage. In particular, an insurance company may have stored a large quantity of conversations between insurance customers and insurance agents in a particular language (e.g., the second language), but not other languages. This large quantity of conversations (wholly or partially) may be used as training dataset 212. Advantageously, the larger dataset being used leads to a better trained chatbot, and provides better answers. Therefore, advantageously, training the chatbot 124 in the second language leads to a better trained chatbot, and provides better answers.

In some embodiments, the input statements (e.g., questions asked by insurance customers) of the training dataset 212 include tags indicating types of insurance policies that the input statements correspond to. For example, an input statement of “what would the monthly auto insurance premium be for this car?” may include a tag of an auto insurance policy. In this way, the chatbot 124 may be trained to determine types of insurance policies corresponding to input statements. For example, the input statement may include “does your insurance company provide disability insurance in state XYZ?” and the tag may indicate that the corresponding type of insurance policy is a disability insurance policy. In some embodiments, the corresponding type of insurance policy is determined by first determining a word or phrase from the input statement, and second determining the type of insurance policy from the word or phrase.

In some embodiments, the prompts and/or responses may include a trigger to retrieve insurance information (e.g., from the ground truth insurance database 140, the internal database 118, the external database 180, etc.). For example, the prompt (e.g., from insurance customer 150) may be “my roof is leaking, will my homeowners insurance policy cover this?” and the response may be “yes, your homeowners insurance policy covers that.” In this example, the trigger may cause the one or more processors 120 to retrieve the information of the insurance customer's 150 homeowners insurance policy.

As mentioned above, in some embodiments, the ML model 250 may comprise a conversation AI or ML algorithm, which may comprise a homeowners insurance AI or ML algorithm, a renters insurance AI or ML algorithm, an auto insurance AI or ML algorithm, a life insurance AI or ML algorithm, a disability insurance AI or ML algorithm, a personal articles or personal belongings insurance AI or ML algorithm, and/or an umbrella insurance AI or ML algorithm are comprised in a conversation AI or ML algorithm. In some such embodiments, the supervised training dataset 212 may include data that is specific to individual AI or ML algorithms.

For example, for a homeowners insurance AI or ML algorithm, the supervised training dataset 212 may include historical homeowners insurance conversation data comprising: (i) independent variables comprising historical homeowners insurance questions, and/or (ii) dependent variables comprising historical answers to the historical homeowners insurance questions. In some embodiments, the historical homeowners insurance questions are in the second language, and/or the historical answers to the historical homeowners insurance questions are in the second language.

In another example, for a renters insurance AI or ML algorithm, the supervised training dataset 212 may include conversation data comprising: (i) independent variables comprising historical renters insurance questions, and/or (ii) dependent variables comprising historical answers to the historical renters insurance questions. In some embodiments, the historical renters insurance questions are in the second language, and/or the historical answers to the historical renters insurance questions are in the second language.

In yet another example, for an auto insurance AI or ML algorithm, the supervised training dataset 212 may include historical auto insurance conversation data comprising: (i) independent variables comprising historical auto insurance questions, and/or (ii) dependent variables comprising historical answers to the historical auto insurance questions. In some embodiments, the historical auto insurance questions are in the second language, and/or the historical answers to the historical auto insurance questions are in the second language.

In yet another example, for a personal articles AI or ML algorithm, the supervised training dataset 212 may include historical personal articles or personal belongings conversation data comprising: (i) independent variables comprising historical personal articles or personal belongings questions, and/or (ii) dependent variables comprising historical answers to the historical personal articles or personal belongings questions. In some embodiments, the historical personal articles or personal belongings questions are in the second language, and/or the historical answers to the historical personal articles or personal belongings questions are in the second language.

In yet another example, for a life insurance AI or ML algorithm, the supervised training dataset 212 may include historical life insurance conversation data comprising: (i) independent variables comprising historical life insurance questions, and/or (ii) dependent variables comprising historical answers to the historical life insurance questions. In some embodiments, the historical life insurance questions are in the second language, and/or the historical answers to the historical life insurance questions are in the second language.

In yet another example, for a disability insurance AI or ML algorithm, the supervised training dataset 212 may include historical disability insurance conversation data comprising: (i) independent variables comprising historical disability insurance questions, and/or (ii) dependent variables comprising historical answers to the historical disability insurance questions. In some embodiments, the historical disability insurance questions are in the second language, and/or the historical answers to the historical disability insurance questions are in the second language.

In yet another example, for an umbrella insurance AI or ML algorithm, the supervised training dataset 212 may include historical umbrella insurance conversation data comprising: (i) independent variables comprising historical umbrella insurance questions, and/or (ii) dependent variables comprising historical answers to the historical umbrella insurance questions. In some embodiments, the historical umbrella insurance questions are in the second language, and/or the historical answers to the historical umbrella insurance questions are in the second language.

In some examples including the conversation AI or ML algorithm, the conversation AI or ML algorithm may be trained based upon historical data comprising: (i) independent variables comprising historical questions from historical insurance customers, and/or (ii) dependent variables comprising answers from historical insurance agents. In some embodiments, the historical questions are in the second language, and/or the historical answers are in the second language.

### Training the Reward Model

In one aspect, training the ML chatbot model 250 may include, at block 204, training a reward model 220 to provide as an output a scaler value/reward 225. The reward model 220 may be required to leverage Reinforcement Learning with Human Feedback (RLHF) in which a model (e.g., ML chatbot model 250) learns to produce outputs which maximize its reward 225, and in doing so may provide responses which are better aligned to user prompts.

Training the reward model 220 may include, at block 204, providing a single prompt 222 to the SFT ML model 215 as an input. The input prompt 222 may be provided via an input device (e.g., a keyboard) of the computing device 102. The prompt 222 may be previously unknown to the SFT ML model 215, e.g., the labelers may generate new prompt data, the prompt 222 may include testing data stored on internal database 118, and/or any other suitable prompt data. The SFT ML model 215 may generate multiple, different output responses 224A, 224B, 224C. 224D to the single prompt 222. At block 204, the computing device 102 (and/or the insurance customer computing device 155, insurance agent computing device 165, etc.) may output the responses 224A, 224B, 224C, 224D via any suitable technique, such as outputting via a display (e.g., as text responses), a speaker (e.g., as audio/voice responses), etc., for review by the data labelers.

In some embodiments, the different output responses 224A, 224B, 224C, 224D are determined by determining a question and corresponding type of insurance policy from the input 222 (e.g., an input statement, which may itself be a question). In some such embodiments, the different output responses 224A, 224B, 224C, 224D are determined by retrieving (e.g., from the ground truth insurance database 140, the internal database 118, the external database 180, etc.) insurance information based upon (i) the type of insurance policy, and (ii) the question. In some embodiments, the different output responses 224A, 224B, 224C, 224D are further determined by using an estimation AI algorithm (e.g., an AI algorithm that estimates a value of a home, etc.).

The data labelers may provide feedback (e.g., via the computing device 102, the insurance agent computing device 165, etc.) on the responses 224A, 224B, 224C, 224D when ranking 226 them from best to worst based upon the prompt-response pairs. The data labelers may rank 226 the responses 224A, 224B, 224C, 224D by labeling the associated data. The ranked prompt-response pairs 228 may be used to train the reward model 220. In one aspect, the computing device 102 may load the reward model 220 via the chatbot training application 126 and train the reward model 220 using the ranked response pairs 228 as input. The reward model 220 may provide as an output the scalar reward 225.

In one aspect, the scalar reward 225 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 220 may generate a winning reward. Inputting a “losing” prompt-response pair data to the same reward model 220 may generate a losing reward. The reward model 220 and/or scalar reward 236 may be updated based upon labelers ranking 226 additional prompt-response pairs generated in response to additional prompts 222.

In one example, a data labeler may provide to the SFT ML model 215 as an input prompt 222, “Describe the sky.” The input may be provided by the labeler (e.g., via the computing device 102, etc.) to the computing device 102 running chatbot 124 utilizing the SFT ML model 215. The SFT ML model 215 may provide as output responses to the labeler (e.g., via their respective devices): (i) “the sky is above” 224A; (ii) “the sky includes the atmosphere and may be considered a place between the ground and outer space” 224B; and (iii) “the sky is heavenly” 224C. The data labeler may rank 226, via labeling the prompt-response pairs, prompt-response pair 222/224B as the most preferred answer; prompt-response pair 222/224A as a less preferred answer; and prompt-response 222/224C as the least preferred answer. The labeler may rank 226 the prompt-response pair data in any suitable manner. The ranked prompt-response pairs 228 may be provided to the reward model 220 to generate the scalar reward 225. It should be appreciated that this facilitates training the chatbot 124 to determine questions corresponding various types of insurance policies, and answers corresponding to the types of insurance policies.

While the reward model 220 may provide the scalar reward 225 as an output, the reward model 220 may not generate a response (e.g., text). Rather, the scalar reward 225 may be used by a version of the SFT ML model 215 to generate more accurate responses to prompts, i.e., the SFT model 215 may generate the response such as text to the prompt, and the reward model 220 may receive the response to generate a scalar reward 225 of how well humans perceive it. Reinforcement learning may optimize the SFT model 215 with respect to the reward model 220 which may realize the configured ML chatbot model 250.

### RLHF to Train the ML Chatbot Model

In one aspect, the computing device 102 may train the ML chatbot model 250 (e.g., via the chatbot training application 126) to generate a response 234 to a random, new and/or previously unknown user prompt 232. To generate the response 234, the ML chatbot model 250 may use a policy 235 (e.g., algorithm) which it learns during training of the reward model 220, and in doing so may advance from the SFT model 215 to the ML chatbot model 250. The policy 235 may represent a strategy that the ML chatbot model 250 learns to maximize its reward 225. As discussed herein, based upon prompt-response pairs, a human labeler may continuously provide feedback to assist in determining how well the ML chatbot's 250 responses match expected responses to determine rewards 225. The rewards 225 may feed back into the ML chatbot model 250 to evolve the policy 235. Thus, the policy 235 may adjust the parameters of the ML chatbot model 250 based upon the rewards 225 it receives for generating good responses. The policy 235 may update as the ML chatbot model 250 provides responses 234 to additional prompts 232.

In one aspect, the response 234 of the ML chatbot model 250 using the policy 235 based upon the reward 225 may be compared using a cost function 238 to the SFT ML model 215 (which may not use a policy) response 236 of the same prompt 232. The server 206 may compute a cost 240 based upon the cost function 238 of the responses 234, 236. The cost 240 may reduce the distance between the responses 234, 236, i.e., a statistical distance measuring how one probability distribution is different from a second, in one aspect the response 234 of the ML chatbot model 250 versus the response 236 of the SFT model 215. Using the cost 240 to reduce the distance between the responses 234, 236 may avoid a server over-optimizing the reward model 220 and deviating too drastically from the human-intended/preferred response. Without the cost 240, the ML chatbot model 250 optimizations may result in generating responses 234 which are unreasonable but may still result in the reward model 220 outputting a high reward 225.

In one aspect, the responses 234 of the ML chatbot model 250 using the current policy 235 may be passed by the server 206 to the rewards model 220, which may return the scalar reward or discount 225. The ML chatbot model 250 response 234 may be compared via cost function 238 to the SFT ML model 215 response 236 by the server 206 to compute the cost 240. The server 206 may generate a final reward 242 which may include the scalar reward 225 offset and/or restricted by the cost 240. The final reward or discount 242 may be provided by the server 206 to the ML chatbot model 250 and may update the policy 235, which in turn may improve the functionality of the ML chatbot model 250.

To optimize the ML chatbot model 250 over time, RLHF via the human labeler feedback may continue ranking 226 responses of the ML chatbot model 250 versus outputs of earlier/other versions of the SFT ML model 215, i.e., providing positive or negative rewards 225. The RLHF may allow the chatbot training application 126 to continue iteratively updating the reward model 220 and/or the policy 235. As a result, the ML chatbot model 250 may be retrained and/or fine-tuned based upon the human feedback via the RLHF process, and throughout continuing conversations may become increasingly efficient.

Although multiple blocks 202, 204, 206 are depicted in the exemplary block and logic diagram 200, each providing one of the three steps of the overall ML chatbot model 250 training, fewer and/or additional servers may be utilized and/or may provide the one or more steps of the chatbot 124 training. In one aspect, one server may provide the entire ML chatbot model 250 training.

Estimation AI and/or ML Algorithms

Some embodiments involve using an estimation AI or machine learning (ML) algorithm as part of determining the answer to the question. For example, an estimation AI or ML algorithm may be used to estimate a value of a home. However, this example should not be construed as limiting.

In one working example, the insurance customer 150 asks the chatbot 124 “what would the annual insurance premium for the house at 123 Main Street be?” And, the chatbot 124 may determine the answer to be “Because we have estimated the value of your home as $XYZ, the annual insurance premium would be $ABC.” In this example, the chatbot 124 uses the estimation AI or ML algorithm to determine the $XYZ value.

The estimation AI or ML algorithm may be trained from any suitable data. For instance, if the estimation AI or ML algorithm estimates values of homes, the estimation AI or ML algorithm may be trained based upon historical data related to values of homes. For instance, the historical data may include independent variables of: year built of home, square footage of home, number of bathrooms of home, number of bedrooms of home, etc. Further in this example, the historical data may include dependent variables values of homes. In this way the estimation AI or ML algorithm “learns” the relationships between the independent variables and the dependent variables.

### Exemplary Computer-Implemented Methods

In certain embodiments, generative artificial intelligence (AI) models (also referred to as generative machine learning (ML) models) including voice bots or chatbots may be configured to utilize artificial intelligence and/or machine learning techniques. Data input into the voice bots, chatbots, or other bots may include historical insurance claim data, historical home data, historical water or fire damage data, sensor information, damage mitigation and prevention techniques, and other data. The data input into the bot or bots may include text, documents, and images, such as text, documents and images related to homes, claims, and water damage, damage mitigation and prevention, and sensors. In certain embodiments, a voice or chatbot may be a ChatGPT chatbot. The voice or chatbot may employ supervised or unsupervised machine learning techniques, which may be followed by, and/or used in conjunction with, reinforced or reinforcement learning techniques. In one aspect, the voice or chatbot may employ the techniques utilized for ChatGPT. The voice bot, chatbot, ChatGPT-based bot, ChatGPT bot, and/or other such generative model may generate audible or verbal output, text or textual output, visual or graphical output, output for use with speakers and/or display screens, and/or other types of output for user and/or other computer or bot consumption.

FIG. 7 shows an exemplary computer-implemented method or implementation 700 for AI-based communication with an insurance customer. Although the following discussion refers to the exemplary method or implementation 700 as being performed by the one or more processors 120, it should be understood that any or all of the blocks may be alternatively or additionally performed by any other suitable component as well (e.g., one or more processors of the insurance customer computing device 155, one or more processors of the insurance agent computing device 165, etc.).

The exemplary implementation 700 may begin at block 705 when the one or more processors 120 (e.g., via the chatbot 124) receive a question in a first language. In some embodiments, the question is comprised in an input statement (also in the first language), and the one or more processors 120 determine the question from the input statement. The question and/or input statement may be received via the insurance customer computing device 155 and/or the insurance agent computing device 165.

The first language may be any language. Examples of the first language include: English; Spanish; French; German; Portuguese; Italian; Japanese; Arabic; Russian; Korean; Hindi; Turkish; Indonesia; Bengali; American Sign Language; Thai; Vietnamese; Dutch; Urdu; Marathi; Hungarian; and/or Telugu. For instance, in the example of FIG. 3, the first language is Spanish, and the question is “¿Cuál es la prima anual de una póliza de seguro de propietario de vivienda para la casa en 123 Main Street?”

At block 710, the one or more processors 120 (e.g., via the chatbot 124) may apply a Natural Language Processing (NLP) algorithm to the question. In variations where the question comprises audio data, the one or more processors 120 may first apply an audio recognition program to the audio data to generate text, and then apply the NLP algorithm to the generated text. The NLP algorithm may generate words or phrases.

At block 715, the one or more processors 120 (e.g., via the chatbot 124) may translate the question from the first language to a second language. The second language may be any language. Examples of the second language include: English; Spanish; French; German; Portuguese; Italian; Japanese; Arabic; Russian; Korean; Hindi; Turkish; Indonesia; Bengali; American Sign Language; Thai; Vietnamese; Dutch; Urdu; Marathi; Hungarian; and/or Telugu.

The translation may be accomplished by any suitable technique. For example, a translation algorithm may be used. For example, computer-aided translation (CAT) may be used. The CAT may include use of translation memory tools (e.g., including a database of text segments in one language, and their translation in another language). The CAT may also include spell checkers (e.g., included in word processing software, or as add-on programs). The CAT may still further include: terminology managers (e.g., to manage terminology banks in electronic form); electronic dictionaries (e.g., unilingual or bilingual); terminology databases; search tools (e.g., indexers) (e.g., allowing a user to query translated texts); concordances (e.g., programs to retrieve instances of a word or expression and/or their respective context in a monolingual, bilingual or multilingual corpus), etc.

The translation may be done directly to the question received at block 705 (e.g., as with all blocks, block 710 does not have to be performed). Additionally or alternatively, the translation may be performed on the words or phrases generated at block 710.

At block 720, the one or more processors 120 may determine (e.g., via the chatbot 124), from the translated question, a type of insurance policy. Examples of the type of insurance policy include a homeowners insurance policy, a renters insurance policy, an auto insurance policy, a life insurance policy, a disability insurance policy, and/or an umbrella insurance policy. Any suitable technique may be used to determine the type of insurance policy. For example, key word(s) in the question may be used to determine the type of insurance policy. For instance, if a question includes the phrase “life insurance” the one or more processors 120 may determine the type of insurance policy to be a life insurance policy.

At block 725, the one or more processors 120 may determine (e.g., via the chatbot 124) if the answer should include an estimation. For example, if the question relates to homeowners insurance, the chatbot 124 may determine that the answer should include an estimation of the value of a home.

If the determination at block 725 is yes, the one or more processors 120 (e.g., via the chatbot 124) may access the estimation AI algorithm at block 730. For example, the one or more processors 120 (e.g., via the chatbot 124) may access the estimation AI algorithm to determine the value of a home.

Following block 730, or if the determination at block 725 is no, the one or more processors 120 (e.g., via the chatbot 124) may determine the answer to the question at block 735.

The techniques for training the chatbot 124 to answer questions are discussed elsewhere herein (e.g., with respect to FIG. 2, etc.). The answer may include the estimation made at block 730.

In some embodiments, the chatbot 124 accesses different models (e.g., ML model 250 of FIG. 2) depending on the type of insurance policy that was determined at block 720. For instance, there may be a conversation AI or ML algorithm, which may comprise a homeowners insurance AI or ML algorithm, a renters insurance AI or ML algorithm, an auto insurance AI or ML algorithm, a life insurance AI or ML algorithm, a disability insurance AI or ML algorithm, and/or an umbrella insurance AI or ML algorithm are comprised in a conversation AI or ML algorithm. As discussed above, each of the AI or ML algorithms are different because they are trained on different data (e.g., the supervised training dataset 212 may include data that is specific to individual AI or ML algorithms).

In addition, some embodiments may use query vectors, key vectors, and/or value vectors. For example, the one or more processors 120 (e.g., via the chatbot 124) may generate tokens (e.g., at block 710 by applying an NLP algorithm to text of the input statement; or by first applying an audio recognition program to the input statement, and then applying the NLP algorithm) from the input statement, with each token comprising a word or phrase. The one or more processors 120 (e.g., via the chatbot 124) may then build a query vector, a key vector, and/or a value vector for each token. The one or more processors 120 (e.g., via the chatbot 124) may then determine a similarity metric between a particular query vector and each key vector by taking respective dot products of the particular query vector and each key vector. The one or more processors 120 (e.g., via the chatbot 124) may then generate normalized weights by routing the respective dot products into a softmax function; and may then generate a final vector by multiplying the normalized weights by the value vector of the token, with the final vector representing an importance of the token. The one or more processors 120 (e.g., via the chatbot 124) may then base the determination(s) of any of: the type of insurance policy (e.g., block 720), and/or the answer to the question (e.g., block 735) upon the final vector.

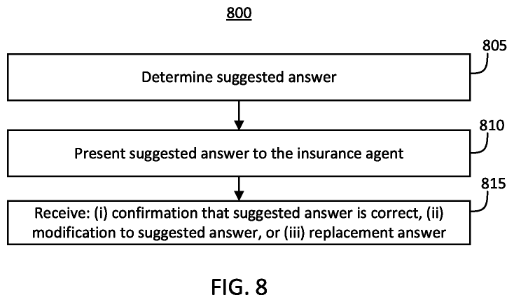

In some embodiments, determining the answer involves presenting a suggested answer to the insurance agent 160. In this regard, FIG. 8 depicts an exemplary flowchart, including presenting a suggested answer to an insurance agent 160. In this example, at block 805, the chatbot 124 determines an answer to the question, as discussed above with respect to blocks 705-735 of FIG. 7. However, the determined answer is then presented as a suggested answer (e.g., at block 810) to the insurance agent 160 (e.g., via the insurance agent computing device 165). Such an example is depicted on exemplary screen 400 of FIG. 4.

At block 815, the one or more processors 120 (e.g., via the chatbot 124) may receive: (i) confirmation that the suggested answer is correct (e.g., the insurance agent 160 selected button 440); (ii) a modified answer (e.g., that the insurance agent 160 entered via exemplary screen 500); or (iii) a replacement answer (e.g., that the insurance agent 160 entered via exemplary screen 600).

In such embodiments, returning to block 735, the one or more processors 120 (e.g., via the chatbot 124) may then determine the answer to be the confirmed answer, the modified answer, or the replacement answer, depending on the insurance agent's 160 response.

At block 740 the one or more processors 120 (e.g., via the chatbot 124) may translate the answer to the first language. The translation may be accomplished by any suitable technique. For example, a translation algorithm may be used. For example, computer-aided translation (CAT) may be used. The CAT may include use of translation memory tools (e.g., including a database of text segments in one language, and their translation in another language). The CAT may also include spell checkers (e.g., included in word processing software, or as add-on programs). The CAT may still further include: terminology managers (e.g., to manage terminology banks in electronic form); electronic dictionaries (e.g., unilingual or bilingual); terminology databases; search tools (e.g., indexers) (e.g., allowing a user to query translated texts); concordances (e.g., programs to retrieve instances of a word or expression and/or their respective context in a monolingual, bilingual or multilingual corpus), etc.

At block 745, the answer (e.g., translated to the first language) may be presented to the insurance customer 150 (e.g., via the insurance customer computing device), such as illustrated by answer 330 of the exemplary screen 300 of FIG. 3.

However, to present the answer, the answer does not necessarily need to be displayed. For example, the answer may be verbally or audibly presented (e.g., via the insurance customer computing device 155).

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Additional Exemplary Embodiments

In one aspect, a computer-implemented method for artificial intelligence (AI)-based communication with an insurance customer may be provided. The method may be implemented via one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For instance, in one example, the method may include: (1) receiving, via a chatbot of one or more processors, a question in a first language; (2) translating, via the chatbot, the question from the first language to a second language; (3) determining, via the chatbot, an answer to the translated question, the answer being determined in the second language; (4) translating, via the chatbot, the answer from the second language to the first language; and/or (5) presenting (such as verbally or audibly speaking or presenting, or displaying on a display screen or otherwise displaying), via the chatbot, the answer in the first language to an insurance customer. The method may include additional, fewer, or alternate actions, including those discussed elsewhere herein.

In some embodiments, the determining the answer to the translated question includes, via the chatbot: inputting the question in the second language into a conversation AI or machine learning (ML) algorithm, wherein the conversation AI or ML algorithm was trained based upon historical conversations between historical insurance customers and historical insurance agents, wherein the historical conversations are in the second language.

In some embodiments, the method further includes training, via the one or more processors, a conversation AI or machine learning (ML) algorithm based upon historical data comprising: (i) independent variables comprising historical questions from historical insurance customers, and/or (ii) dependent variables comprising answers from historical insurance agents, wherein the historical questions are in the second language, and the historical answers are in the second language; and/or wherein the determining the answer to the translated question includes, via the chatbot, inputting the question in the second language into the conversation AI or ML algorithm.

In some embodiments, the first language and/or second language comprises: English; Spanish; French; German; Portuguese; Italian; Japanese; Arabic; Russian; Korean; Hindi; Turkish; Indonesia; Bengali; American Sign Language; Thai; Vietnamese; Dutch; Urdu; Marathi; Hungarian; and/or Telugu.

In certain embodiments, the determining the answer to the translated question includes, via the chatbot: determining a suggested answer to the translated question; presenting, via an insurance agent computing device, the suggested answer to an insurance agent; receiving, from the insurance agent computing device, confirmation that the suggested answer is correct; and/or in response to receipt of the confirmation, determining the answer to be the suggested answer.

In some embodiments, the determining the answer to the translated question includes, via the chatbot: determining a suggested answer to the translated question; presenting, via an insurance agent computing device, the suggested answer to an insurance agent; receiving, from the insurance agent computing device, a modified suggested answer including a modification to the suggested answer; and/or in response to receipt of the modification, determining the answer to be the modified suggested answer.

In some embodiments, the determining the answer to the translated question includes, via the chatbot: determining a suggested answer to the translated question; presenting, via an insurance agent computing device, the suggested answer to an insurance agent; receiving, from the insurance agent computing device, a replacement answer; and/or in response to receipt of the replacement answer, determining the answer to be the replacement answer.

In certain embodiments, the chatbot includes: an AI chatbot, a machine learning (ML) chatbot, a generative AI chatbot, a deep learning algorithm, a generative pre-trained transformer (GPT), and/or long-short-term-memory (LSTM).

In some embodiments: the question in the first language comprises audio data; the method further comprises, with the chatbot, (i) applying an audio recognition program to the audio data to generate text, and (ii) applying a natural language processing (NLP) algorithm to the text to generate words or phrases; and/or the translating comprises translating the words or phrases from the first language to the second language.

In certain embodiments: the question in the first language comprises text; the method further comprises, with the chatbot, applying a natural language processing (NLP) algorithm to the text to generate words or phrases; and/or the translating comprises translating the words or phrases from the first language to the second language.

In some embodiments, the method further includes, via the one or more processors: with the chatbot, applying a natural language processing (NLP) algorithm to text of the question to generate a plurality of tokens, each token comprising a word or phrase; building, with the chatbot, a query vector, a key vector, and/or a value vector for each token of the plurality of tokens; determining, with the chatbot, a similarity metric between a built query vector of a token of the plurality of tokens and each built key vector by taking respective dot products of the built query vector and each built key vector; generating, with the chatbot, normalized weights by routing the respective dot products into a softmax function; and/or generating, with the chatbot, a final vector by multiplying the normalized weights by the value vector of the token of the plurality of token, wherein the final vector represents an importance of the token of the plurality of tokens.

In some embodiments, the determining the answer comprises determining the answer based upon the final vector. Additionally or alternatively, in certain embodiments: the determining the answer comprises determining, with the chatbot, that the answer to the question is related to an estimation; and/or in response to determining that the answer to the question is related to the estimation, the determining the answer to the question further comprises the chatbot using an estimation AI or machine learning (ML) algorithm to determine the answer to the question.

In some embodiments, the question is related to a value of a home (or personal articles), and/or the estimation is an estimation of a value of the home (or personal article, such as a painting, piece of jewelry, antique, coin collection, electronic devices, televisions, furniture, appliances, clothing, etc.); and/or the estimation AI or ML algorithm is trained to estimate home values.

In some embodiments, the method further includes: training, via the one or more processors, a homeowners insurance AI or machine learning (ML) algorithm based upon historical homeowners insurance conversation data comprising: (i) independent variables comprising historical homeowners insurance questions, and/or (ii) dependent variables comprising historical answers to the historical homeowners insurance questions, wherein the historical homeowners insurance questions are in the second language, and the historical answers to the historical homeowners insurance questions are in the second language; training, via the one or more processors, a renters insurance AI or ML algorithm based upon historical renters insurance conversation data comprising: (i) independent variables comprising historical renters insurance questions, and/or (ii) dependent variables comprising historical answers to the historical renters insurance questions, wherein the historical renters insurance questions are in the second language, and the historical answers to the historical renters insurance questions are in the second language; training, via the one or more processors, an auto insurance AI or ML algorithm based upon historical auto insurance conversation data comprising: (i) independent variables comprising historical auto insurance questions, and/or (ii) dependent variables comprising historical answers to the historical auto insurance questions, wherein the historical auto insurance questions are in the second language, and the historical answers to the historical auto insurance questions are in the second language; training, via the one or more processors, a life insurance AI or ML algorithm based upon historical life insurance conversation data comprising: (i) independent variables comprising historical life insurance questions, and/or (ii) dependent variables comprising historical answers to the historical life insurance questions, wherein the historical life insurance questions are in the second language, and the historical answers to the historical life insurance questions are in the second language; training, via the one or more processors, a disability insurance AI or ML algorithm based upon historical disability insurance conversation data comprising: (i) independent variables comprising historical disability insurance questions, and/or (ii) dependent variables comprising historical answers to the historical disability insurance questions, wherein the historical disability insurance questions are in the second language, and the historical answers to the historical disability insurance questions are in the second language; and/or training, via the one or more processors, an umbrella insurance AI or ML algorithm based upon historical umbrella insurance conversation data comprising: (i) independent variables comprising historical umbrella insurance questions, and/or (ii) dependent variables comprising historical answers to the historical umbrella insurance questions, wherein the historical umbrella insurance questions are in the second language, and the historical answers to the historical umbrella insurance questions are in the second language.

In some embodiments, the homeowners insurance AI or ML algorithm, the renters insurance AI or ML algorithm, the auto insurance AI or ML algorithm, the life insurance AI or ML algorithm, the disability insurance AI or ML algorithm, the personal articles insurance AI or ML algorithm, and/or the umbrella insurance AI or ML algorithm are comprised in a conversation AI or ML algorithm; and/or the determining the answer to the translated question includes, via the chatbot: (i) determining a type of insurance policy associated with the question, wherein the type of insurance policy is a homeowners insurance policy, a renters insurance policy, an auto insurance policy, a life insurance policy, a disability insurance policy, a personal articles insurance policy, or an umbrella insurance policy; and/or (ii) determining the answer to the translated question by inputting, according to the determined type of insurance policy, the translated question into the homeowners insurance AI or ML algorithm, the renters insurance AI or ML algorithm, the auto insurance AI or ML algorithm, the life insurance AI or ML algorithm, the personal articles insurance AI or ML algorithm, the disability insurance AI or ML algorithm, or the umbrella insurance AI or ML algorithm.

In another aspect, a computer system configured for artificial intelligence (AI)-based communication with an insurance customer may be provided. The computer system may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For example, in one instance, the computer system may include one or more processors configured to: (1) receive, via a chatbot, a question in a first language; (2) translate, via the chatbot, the question from the first language to a second language; (3) determine, via the chatbot, an answer to the translated question, the answer being determined in the second language; (4) translate, via the chatbot, the answer from the second language to the first language; and/or (5) present, via the chatbot, the answer in the first language to an insurance customer. The computer system may include additional, less, or alternate functionality, including that discussed elsewhere herein.

In some embodiments, the computer system further comprises a display device, and/or wherein the one or more processors are further configured to perform the present of the answer by displaying, on the display device, the answer.

In yet another aspect, a computer device configured improved artificial intelligence (AI) insurance analysis may be provided. The computer device may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For instance, in one example, the computer device may include: one or more processors; and/or one or more memories coupled to the one or more processors. The one or more memories including computer executable instructions stored therein that, when executed by the one or more processors, may cause the one or more processors to: (1) receive, via a chatbot, a question in a first language; (2) translate, via the chatbot, the question from the first language to a second language; (3) determine, via the chatbot, an answer to the translated question, the answer being determined in the second language; (4) translate, via the chatbot, the answer from the second language to the first language; and/or (5) present, via the chatbot, the answer in the first language to an insurance customer. The computer device may include additional, less, or alternate functionality, including that discussed elsewhere herein.

In some embodiments, the one or more memories having stored thereon computer executable instructions that, when executed by the one or more processors, cause the one or more processors to perform the present of the answer by displaying, on a display device, the answer.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining.” “presenting.” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising.” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for artificial intelligence (AI)-based communication with an insurance customer, comprising:
receiving, via a chatbot of one or more processors, a question in a first language;
translating, via the chatbot, the question from the first language to a second language;
determining, via the chatbot, an answer to the translated question, the answer being determined in the second language;
translating, via the chatbot, the answer from the second language to the first language; and
presenting (such as verbally or audibly speaking or presenting, or displaying on a display screen or otherwise displaying), via the chatbot, the answer in the first language to an insurance customer.

2. The computer-implemented method of claim 1, wherein the determining the answer to the translated question includes, via the chatbot:
inputting the question in the second language into a conversation AI or machine learning (ML) algorithm, wherein the conversation AI or ML algorithm was trained based upon historical conversations between historical insurance customers and historical insurance agents, wherein the historical conversations are in the second language.

3. The computer-implemented method of claim 1, further comprising training, via the one or more processors, a conversation AI or machine learning (ML) algorithm based upon historical data comprising: (i) independent variables comprising historical questions from historical insurance customers, and/or (ii) dependent variables comprising answers from historical insurance agents, wherein the historical questions are in the second language, and the historical answers are in the second language; and
wherein the determining the answer to the translated question includes, via the chatbot, inputting the question in the second language into the conversation AI or ML algorithm.

4. The computer-implemented method of claim 1, wherein the first language and/or second language comprises: English; Spanish; French; German; Portuguese; Italian; Japanese; Arabic; Russian; Korean; Hindi; Turkish; Indonesia; Bengali; American Sign Language; Thai; Vietnamese; Dutch; Urdu; Marathi; Hungarian; and/or Telugu.

5. The computer-implemented method of claim 1, wherein the determining the answer to the translated question includes, via the chatbot:
determining a suggested answer to the translated question;
presenting, via an insurance agent computing device, the suggested answer to an insurance agent;
receiving, from the insurance agent computing device, confirmation that the suggested answer is correct; and
in response to receipt of the confirmation, determining the answer to be the suggested answer.

6. The computer-implemented method of claim 1, wherein the determining the answer to the translated question includes, via the chatbot:
determining a suggested answer to the translated question;
presenting, via an insurance agent computing device, the suggested answer to an insurance agent;
receiving, from the insurance agent computing device, a modified suggested answer including a modification to the suggested answer; and
in response to receipt of the modification, determining the answer to be the modified suggested answer.

7. The computer-implemented method of claim 1, wherein the determining the answer to the translated question includes, via the chatbot:
determining a suggested answer to the translated question;
presenting, via an insurance agent computing device, the suggested answer to an insurance agent;
receiving, from the insurance agent computing device, a replacement answer; and
in response to receipt of the replacement answer, determining the answer to be the replacement answer.

8. The computer-implemented method of claim 1, wherein the chatbot includes: an AI chatbot, a machine learning (ML) chatbot, a generative AI chatbot, a deep learning algorithm, a generative pre-trained transformer (GPT), and/or long-short-term-memory (LSTM).

9. The computer-implemented method of claim 1, wherein:
the question in the first language comprises audio data;
the method further comprises, with the chatbot, (i) applying an audio recognition program to the audio data to generate text, and (ii) applying a natural language processing (NLP) algorithm to the text to generate words or phrases; and
the translating comprises translating the words or phrases from the first language to the second language.

10. The computer-implemented method of claim 1, wherein:
the question in the first language comprises text;
the method further comprises, with the chatbot, applying a natural language processing (NLP) algorithm to the text to generate words or phrases; and
the translating comprises translating the words or phrases from the first language to the second language.

11. The computer-implemented method of claim 1, further comprising, via the one or more processors:
with the chatbot, applying a natural language processing (NLP) algorithm to text of the question to generate a plurality of tokens, each token comprising a word or phrase;
building, with the chatbot, a query vector, a key vector, and/or a value vector for each token of the plurality of tokens;
determining, with the chatbot, a similarity metric between a built query vector of a token of the plurality of tokens and each built key vector by taking respective dot products of the built query vector and each built key vector;
generating, with the chatbot, normalized weights by routing the respective dot products into a softmax function; and
generating, with the chatbot, a final vector by multiplying the normalized weights by the value vector of the token of the plurality of token, wherein the final vector represents an importance of the token of the plurality of tokens.

12. The computer-implemented method of claim 11, wherein the determining the answer comprises determining the answer based upon the final vector.

13. The computer-implemented method of claim 1, wherein:
the determining the answer comprises determining, with the chatbot, that the answer to the question is related to an estimation; and
in response to determining that the answer to the question is related to the estimation, the determining the answer to the question further comprises the chatbot using an estimation AI or machine learning (ML) algorithm to determine the answer to the question.

14. The computer-implemented method of claim 13, wherein:
the question is related to a value of a home, and the estimation is an estimation of a value of the home; and
the estimation AI or ML algorithm is trained to estimate home values.

15. The computer-implemented method of claim 1, further comprising:
training, via the one or more processors, a homeowners insurance AI or machine learning (ML) algorithm based upon historical homeowners insurance conversation data comprising: (i) independent variables comprising historical homeowners insurance questions, and/or (ii) dependent variables comprising historical answers to the historical homeowners insurance questions, wherein the historical homeowners insurance questions are in the second language, and the historical answers to the historical homeowners insurance questions are in the second language;
training, via the one or more processors, a renters insurance AI or ML algorithm based upon historical renters insurance conversation data comprising: (i) independent variables comprising historical renters insurance questions, and/or (ii) dependent variables comprising historical answers to the historical renters insurance questions, wherein the historical renters insurance questions are in the second language, and the historical answers to the historical renters insurance questions are in the second language;
training, via the one or more processors, an auto insurance AI or ML algorithm based upon historical auto insurance conversation data comprising: (i) independent variables comprising historical auto insurance questions, and/or (ii) dependent variables comprising historical answers to the historical auto insurance questions, wherein the historical auto insurance questions are in the second language, and the historical answers to the historical auto insurance questions are in the second language;
training, via the one or more processors, a life insurance AI or ML algorithm based upon historical life insurance conversation data comprising: (i) independent variables comprising historical life insurance questions, and/or (ii) dependent variables comprising historical answers to the historical life insurance questions, wherein the historical life insurance questions are in the second language, and the historical answers to the historical life insurance questions are in the second language;
training, via the one or more processors, a disability insurance AI or ML algorithm based upon historical disability insurance conversation data comprising: (i) independent variables comprising historical disability insurance questions, and/or (ii) dependent variables comprising historical answers to the historical disability insurance questions, wherein the historical disability insurance questions are in the second language, and the historical answers to the historical disability insurance questions are in the second language; and/or
training, via the one or more processors, an umbrella insurance AI or ML algorithm based upon historical umbrella insurance conversation data comprising: (i) independent variables comprising historical umbrella insurance questions, and/or (ii) dependent variables comprising historical answers to the historical umbrella insurance questions, wherein the historical umbrella insurance questions are in the second language, and the historical answers to the historical umbrella insurance questions are in the second language.

16. The computer-implemented method of claim 15, wherein:
the homeowners insurance AI or ML algorithm, the renters insurance AI or ML algorithm, the auto insurance AI or ML algorithm, the life insurance AI or ML algorithm, the disability insurance AI or ML algorithm, and/or the umbrella insurance AI or ML algorithm are comprised in a conversation AI or ML algorithm; and
the determining the answer to the translated question includes, via the chatbot:
(i) determining a type of insurance policy associated with the question, wherein the type of insurance policy is a homeowners insurance policy, a renters insurance policy, an auto insurance policy, a life insurance policy, a disability insurance policy, or an umbrella insurance policy; and
(ii) determining the answer to the translated question by inputting, according to the determined type of insurance policy, the translated question into the homeowners insurance AI or ML algorithm, the renters insurance AI or ML algorithm, the auto insurance AI or ML algorithm, the life insurance AI or ML algorithm, the disability insurance AI or ML algorithm, or the umbrella insurance AI or ML algorithm.

17. A computer system for artificial intelligence (AI)-based communication with an insurance customer, the computer system comprising one or more processors configured to:
receive, via a chatbot, a question in a first language;
translate, via the chatbot, the question from the first language to a second language;
determine, via the chatbot, an answer to the translated question, the answer being determined in the second language;
translate, via the chatbot, the answer from the second language to the first language; and
present, via the chatbot, the answer in the first language to an insurance customer.

18. The computer system of claim 17, wherein the computer system further comprises a display device, and wherein the one or more processors are further configured to perform the present of the answer by displaying, on the display device, the answer.

19. A computer device for improved artificial intelligence (AI) insurance analysis, the computer device comprising:
one or more processors; and
one or more memories;
the one or more memories having stored thereon computer-executable instructions that, when executed by the one or more processors, cause the one or more processors to:
receive, via a chatbot, a question in a first language;
translate, via the chatbot, the question from the first language to a second language;
determine, via the chatbot, an answer to the translated question, the answer being determined in the second language;
translate, via the chatbot, the answer from the second language to the first language; and
present, via the chatbot, the answer in the first language to an insurance customer.

20. The computer device of claim 19, the one or more memories having stored thereon computer executable instructions that, when executed by the one or more processors, cause the one or more processors to perform the present of the answer by displaying, on a display device, the answer.
